(19) United States
(12) Patent Application Publication
(10) Pub. No.: US 2026/0211919 A1
(43) Pub. Date: Jul. 23, 2026

(54) SYSTEMS AND METHODS FOR GENERATING NARRATIVE-FEED OBJECTS

(71) Applicant: SocialTrendly, Inc. d/b/a Blackbird.AI, Rochester, NY (US)

(72) Inventors: Naushad UzZaman, Bellmore, NY (US); Paul Burkard, Kure Beach, NC (US); Roberta Duffield, Rochester, NY (US); Vanya Cohen, Rochester, NY (US); John Wissinger, Tucson, AZ (US)

(73) Assignee: SocialTrendly, Inc. d/b/a Blackbird.AI, Rochester, NY (US)

(21) Appl. No.: 19/456,198

(22) Filed: Jan. 22, 2026

Related U.S. Application Data
(60) Provisional application No. 63/748,577, filed on Jan. 23, 2025.

(51) Int. Cl. G06F 16/334; G06F 16/353

(52) U.S. Cl. CPC G06F 16/334; G06F 16/353

(57) ABSTRACT

Disclosed embodiments may provide systems and methods for generating a narrative feed. The computer-implemented method can also include extracting a set of narrative-feed objects from a plurality of unstructured data items, in which a narrative-feed object of the set of narrative-feed objects identifies contextual data associated with a corresponding unstructured data item. In some instances, each narrative-feed object of the set of narrative-feed objects includes a set of object-classification signals. The computer-implemented method can also include determining, for each narrative-feed object of the set of narrative-feed objects, signal intensities associated with one or more object-classification signals of the set of object-classification signals. The computer-implemented method can also include determining, for each narrative-feed object of the set of narrative-feed objects, a risk score based on the signal intensities. The computer-implemented method can also include ranking the set of narrative-feed objects based on their respective risk scores.

### CROSS-REFERENCES TO RELATED APPLICATIONS

The present application claims priority from and is a non-provisional of U.S. Provisional Application No. 63/748,577, entitled “SYSTEMS AND METHODS FOR GENERATING NARRATIVE-FEED OBJECTS” filed Jan. 23, 2025, the contents of which are herein incorporated by reference in its entirety for all purposes.

### FIELD

The present disclosure relates generally to process unstructured data to generate a narrative feed. In one example, the systems and methods described herein may be used to process unstructured data to identify signal intensities of various object-classification signals of narrative feed objects.

### SUMMARY

Disclosed embodiments may provide techniques for generating a narrative feed. A computer-implemented method can include accessing a plurality of unstructured data items from a plurality of data sources. In some instances, the plurality of data sources are associated with two or more digital-communication platforms. The computer-implemented method can also include extracting a set of narrative-feed objects from the plurality of unstructured data items, in which a narrative-feed object of the set of narrative-feed objects identifies contextual data associated with a corresponding unstructured data item. In some instances, each narrative-feed object of the set of narrative-feed objects includes a set of object-classification signals. An object-classification signal can identify one or more characteristics associated with the contextual data. In some instances, the set of narrative-feed objects can be extracted by applying a machine-learning model to the plurality of unstructured data items. The set of object-classification signals can include volume, engagement, reach, cohorts, sentiment, toxicity, anomalous behavior, disinformation context, multimodal brand risk, and/or deep fake detection.

The computer-implemented method can also include determining, for each narrative-feed object of the set of narrative-feed objects, signal intensities associated with one or more object-classification signals of the set of object-classification signals. In some instances, the signal intensities are determined based on the plurality of unstructured data items, and a categorical value can be assigned to each of the set of object-classification signals. To determine the signal intensities, the computer-implemented method can also include: (i) applying one or more resource-efficient algorithms to the set of narrative-feed objects to generate one or more signal intensities of the signal intensities; (ii) identifying a filtered subset of the set of narrative-feed objects; and (iii) applying one or more resource-intensive algorithms to the filtered subset of narrative-feed objects to generate remaining signal intensities of the signal intensities, in which the one or more resource-intensive algorithms consume more computing resources relative to computing resources consumed by the one or more resource-efficient algorithms.

The computer-implemented method can also include determining, for each narrative-feed object of the set of narrative-feed objects, a risk score based on the signal intensities. In some instances, the risk score can be determined by applying weights to the signal intensities.

The computer-implemented method can also include ranking the set of narrative-feed objects to generate a narrative feed, in which the ranking is determined based on the risk scores of the set of narrative-feed objects. The computer-implemented method can also include outputting the narrative feed. For example, outputting the narrative feed includes causing a narrative-feed object and a corresponding set of object-classification signals to be displayed at a particular position of a graphical user interface, in which the particular position is determined in accordance with the ranking. In some instances, the computer-implemented method can also include receiving a query that includes unstructured data and re-ranking the set of narrative-feed objects based on the query to generate an updated narrative feed.

Various operations can be performed based on the narrative feed. For example, a remedial operation can be determined based on the set of object-classification signals associated with a narrative-feed object of the set of narrative-feed objects. In another example, a presence of a narrative attack can be determined based on the set of object-classification signals associated with a narrative-feed object of the set of narrative-feed objects.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Illustrative embodiments are described in detail below with reference to the following figures.

FIG. 1 illustrates an example schematic diagram of a computing environment for generating narrative-feed objects, according to some embodiments.

FIG. 2 illustrates an example schematic diagram of a user interface for adjusting weights associated with object-classification signals, according to some embodiments.

FIG. 3 shows an example screenshot of a user interface that displays a narrative-feed object, according to some embodiments.

FIG. 4 shows an illustrative example of a process for generating narrative-feed objects, in accordance with some embodiments.

FIG. 5 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Misinformation on the internet has become a pervasive and concerning issue, presenting a complex challenge that spans various domains. As used herein, misinformation refers to false or misleading information disseminated through online or offline platforms, often with the intent to deceive or manipulate audiences. This misinformation can take many forms, including fake news articles, fabricated images or videos, misleading social media posts, and deceptive websites. The misinformation can spread rapidly across digital networks, amplified by the viral nature of social media and the ease of sharing information online. The consequences of misinformation are far-reaching, ranging from undermining trust in credible sources of information to fueling societal divisions, influencing public opinion, and even inciting real-world harm.

Existing techniques attempt to address misinformation by aggregating data from various data sources and analyzing them to predict misinformation that may harm a particular individual or entity. For example, there are existing techniques that aggregate web documents (e.g., news articles) and predict whether a particular web document includes misinformation. In another example, trending topics or sentiment can be determined based on messages and posts uploaded by a plurality of users. In addition, existing techniques can analyze online behavior and influence operations of users. Other existing techniques such as social listening tools provide sentiment and volume analysis. However, the existing techniques fail to integrate multiple risk signals into narratives that inaccurately or maliciously characterize the individual or the entity, or allow the user to dynamically select, weight, and rank the risk signals.

The present techniques provide a content-streaming application that ingests content from multiple digital sources and extracts a mapping of unstructured data to narrative-feed objects being expressed rather than dealing solely with individual posts. The content-streaming application enriches these narrative-feed objects with various object-classification signals focused on narrative intelligence (e.g., toxicity, bot-likelihood, anomalous activity, sentiment, disinformation context, multimodal brand risk, deep fake detection). The content-streaming application can calculate a customizable risk score to determine which narratives pose the highest risk associated with a given entity.

In some instances, the present techniques utilize a modular architecture where signals and external tools can be integrated. The present techniques can also provide a user interface that clearly communicates narrative priorities with flexible risk ranking controls. Additionally or alternatively, the present techniques can include a “Narrative Feed Agent” that allows users to query or rank the narratives using natural language input. For example, a user can submit targeted questions, at which the Narrative Feed Agent can adjust narrative priority dynamically rather than relying strictly on numeric risk metrics.

The present techniques are directed to an improvement over existing techniques by providing narrative-level and flexible data, which can be further customized using weighting of object-classification signals. Based on the risk scores, certain types of risks can be prioritized (e.g., disinformation context over sentiment) and a user can quickly identify which narratives pose the highest threat or need the most attention. As a result, the present techniques can be utilized to address mission-critical systems that serve national security scenarios emphasizing state-linked disinformation and enterprise systems that focus on brand safety and negative sentiment.

The present techniques can address diverse operational contexts, including national security, brand safety, disinformation analysis, election integrity, and corporate brand management. By leveraging the narrative-feed framework, the present techniques can be implemented to identify opportunities and mitigate risks specific to each domain. For example, in national security, the present techniques can analyze and flag potential narrative attacks by other state actors. In another example, in company branding, the present techniques can identify narratives that provides an opportunity to expand into a new business domain. In yet another example, the present techniques can ensure election integrity by detecting and countering disinformation campaigns. The versatility of the present techniques not only underscores its utility but also demonstrates the capacity to operate effectively across multiple domains.

### I. Techniques for Using Machine-Learning to Generate Narrative-Feed Objects

The present techniques provide a system and method for aggregating large volumes of digital content (e.g., posts, images, videos, text) and extracting a mapping of posts to the narrative(s) they express in the document and then applying a range of enriched signals, such as volume, engagement, cohort influence, sentiment, toxicity, anomalous behavior, disinformation context, deep fake detection, and multimodal brand risk. Unlike existing post-level or feed-level analysis tools, the present techniques enable narrative-level intelligence by reducing millions of posts to a manageable set of prioritized narratives. In some instances, a customizable risk-scoring module allows for flexible weighting of signals to cater to distinct operational contexts-such as national security analysis, brand safety, or mis/disinformation monitoring-thereby surfacing the most critical narratives relevant to a given mission or organizational priority.

### A. Computing Environment

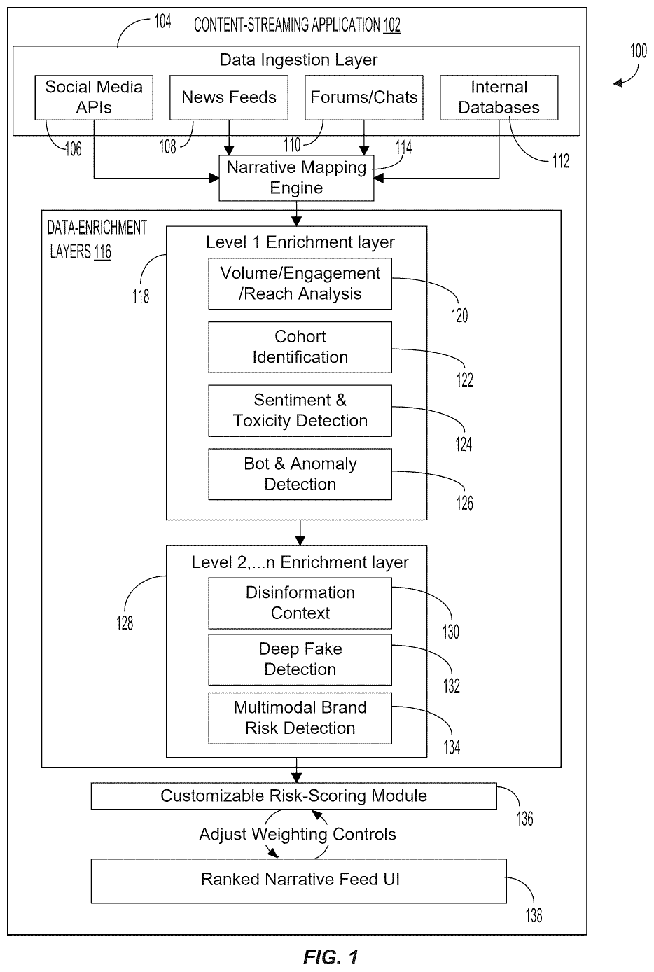

FIG. 1 illustrates an example schematic diagram 100 of a computing environment for generating narrative-feed objects, according to some embodiments. In FIG. 1, a data ingestion layer 104 of a content-streaming application 102 accesses a plurality of unstructured data items from a plurality of data sources. The unstructured data items can include information that does not conform to a predefined format or a data model. The unstructured data items can include free-form text, multimedia files, or other non-standardized formats. In some instances, an unstructured data item includes multimodal data including a combination of video data, audio data, and/or text data. Examples of unstructured data items can include social media posts, news articles, videos, audio recordings, text streams uploaded by users, and any combinations thereof. In some instances, the data ingestion layer 104 accesses and dynamically processes the plurality of unstructured items in real-time, such that the narrative-feed objects can be generated based on the most recent information. Additionally or alternatively, the data ingestion layer 104 accesses the plurality of unstructured items in batches, at which the narrative-feed objects can be generated offline. The offline batch processing facilitates generating the narrative-feed objects using less computing resources. The plurality of data sources can be associated with two or more digital-communication platforms.

In some instances, the data ingestion layer 104 can access the unstructured data item from several digital content sources, including social media APIs 106, news feeds 108, forums/chats 110, and internal databases 112. The data ingestion layer 104 can access the plurality of unstructured data items from the data sources via a communication network. The network can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications by the client device via the network can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

### 1. Narrative-Mapping Engine

The content-streaming application 102 can include a narrative-mapping engine 114 configured to extract a set of narrative-feed objects from the plurality of unstructured data items. A narrative-feed object can identify contextual data associated with a corresponding unstructured data item. For example, the narrative-mapping engine 114 can include a data-extraction engine that extracts a mapping of the unstructured data items (e.g., social media posts) to the narrative-feed objects, in which the mapping can be based on thematic or topical similarity and relevant claims associated with the narrative-feed objects. In some instances, two or more narrative-feed objects can be extracted based on a single unstructured data item. Stated differently, an unstructured data item can be mapped to a single narrative-feed object, or multiple narrative-feed objects.

In some instances, the narrative-mapping engine 114 can extract the set of narrative-feed objects by applying a machine-learning model to the plurality of unstructured data items to generate the set of narrative-feed objects. In some instances, the machine-learning model is a multi-lingual model configured to process multiple human languages. The machine-learning model can include a natural-language processing model trained to parse unstructured and structured data associated with the model prompts. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data. In addition to training the model, various prompts can be used for prompt engineering of the machine-learning model for generating the qualification indicator. Examples of the machine-learning model can include, but are not limited to, BERT model, Claude LLM, Falcon 40B, Ernie, GPT-3, GPT-3.5, GPT 4, Lamda, and Llama.

In some instances, the machine-learning model can be generated based on different types of machine-learning architectures. An example architecture used for transformer models can include a transformer model that includes an encoder and a decoder. Another example can include a Bidirectional Encoder Representations from Transformers (BERT), which is configured to understand the context of a word in search queries by considering the words on both its left and right. In yet another example, a machine-learning architecture can include a Generative Pre-trained Transformer (GPT) that is trained using autoregressive language modeling and masked self-attention techniques. For example, the masked self-attention techniques can include masking future tokens when generating a contextual representation representing a given token, such that the contextual representation is determined only based on past tokens. The autoregressive language modeling techniques can then predict the next token of an output sequence based on the contextual representations of the text tokens.

Other examples of machine-learning architectures can include: (1) a Text-to-Text Transfer Transformer (T5) that converts all natural-language processing tasks into a text-to-text format, unifying various tasks under a single model architecture; and (2) a Vision Transformer (ViT) that extends the transformer architecture to process longer text sequences and image data, respectively, thereby facilitating the corresponding model to be used across different domains.

An illustrative example process of training the transformer model (e.g., a GPT model) is as follows. For the training dataset (e.g., the previous input data and corresponding model-generated narrative content), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using a masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the narrative-mapping engine 114 can construct one or more prompts that can be submitted with the unstructured data items to extract the narrative-feed objects. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used to iteratively refine the prompt P to maximize O(P,R), to facilitate the model to consistently produce accurate, relevant, and contextually appropriate outputs (e.g., the model-generated narrative content 422). For example, the optimal prompt P* can be determined based on maximizing the objective function O:

$${P}^{*} = arg max O ( P , LM ( P ) ) \qquad Equation ( 1 )$$

Through the iterative refinement process, prompt engineering enhances the corresponding model's performance across various natural language processing tasks, such as generating the narrative-feed objects that are contextually relevant to the unstructured data items.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The narrative-mapping engine 114 can apply the trained and fine-tuned machine-learning model to the unstructured data items to identify the narrative-feed objects. To begin the deployment process, the narrative-mapping engine 114 can tokenize the multimodal data input as a sequence of text tokens. For example, the multimodal data can be tokenized to provide the following sequence: [“You”, “are”, “an”, “assistant”, “tasked”, . . . ]. In some instances, the machine-learning model uses Byte Pair Encoding (BPE) techniques to further split a single token (e.g., “in”, “sufficient”).

The narrative-mapping engine 114 can assign each token with a particular index value in the vocabulary (e.g., “assistant”=E[5]). Then, the narrative-mapping engine 114 can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value of a corresponding row of embedding matrix E.

$$E : {e}_{i} = E [ {t}_{i} ] \qquad Equation ( 2 )$$

The narrative-mapping engine 114 can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the narrative-mapping engine 114 can then determine a contextual representation for each position-encoded vector of the matrix X. In particular, for each position-encoded vector, the narrative-mapping engine 114 can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

$$Attention ( Q , K , V ) = softmax ( ( Q {K}^{T} ) / √ ( {d}_{k} ) ) V \qquad Equation ( 3 )$$

The (QK^{T})/√(dₖ) can be used to compute the raw attention scores, in which dₖ is the dimensionality of the key vectors. Then, the softmax function is applied to the raw attention score to normalize it into a probability distribution. The narrative-mapping engine 114 can apply the attention score to a V vector of the corresponding set of Q, K, V vectors, such that the weighted Q, K, V vectors can be used as the contextual representation of the position-encoded vector of matrix X In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the unstructured data items.

The narrative-mapping engine 114 can then apply the machine-learning model to the set of contextual representations to extract the narrative-feed objects from the unstructured data items. In particular, the machine-learning model can process the set of contextual representations to predict each token of the output, in which the output tokens can correspond to the narrative-feed objects.

### 2. Object Classification Signals

In some instances, each narrative-feed object of the set of narrative-feed objects can include a set of object-classification signals. An object-classification signal can identify one or more characteristics associated with the contextual data of the narrative-feed object. For example, the set of object-classification signals includes the following signals for a given contextual data associated with the corresponding narrative-feed object:
1. Volume signal identifies an amount of unstructured data items (e.g., a number of posts, comments, or mentions) describing the contextual data.
2. Engagement signal identifies an amount of interaction (e.g., likes, shares, comments, views) with unstructured data items that are associated with the contextual data.
3. Reach signal identifies a number of unique users or devices that were exposed to the unstructured data items associated with the contextual data.
4. Cohorts signal identifies a number of categorized groups of users or entities that are associated with the contextual data.
5. Sentiment signal identifies an amount of unstructured data items that express emotional tones (e.g., positive, negative, neutral) for or against the contextual data.
6. Toxicity signal identifies an amount of unstructured data items that include harmful or offensive language within content, including abusive, harassing, or inflammatory remarks.
7. Anomalous-behavior signal identifies an amount of unstructured data items reflecting deviations (e.g., suspicious activities) from baseline user behavior.
8. Disinformation context signal identifies an amount of unstructured data items having potentially false or misleading information about the contextual data.
9. Multimodal signal identifies an amount of unstructured data items having multiple content types (e.g., text, images, video) that include potential or actual threats, harmful information, or controversial information that negatively affects an entity associated with the contextual data.
10. Deep fake detection signal identifies the degree of synthetic or manipulated media content (e.g., videos, images) present that misrepresent the contextual data

In some instances, each object-classification signal is associated with a corresponding signal intensity. The signal intensity can indicate a magnitude or an extent of the one or more characteristics of the object-classification signal. For example, a very-low signal intensity of a given deep fake detection signal can indicate that there are no synthetic images that were generated in relation to the contextual data identified by the narrative-feed object. In another example, a high signal intensity of a given sentiment signal can indicate that there are several social-media posts that reacted strongly to the contextual data identified by the narrative-feed object.

In some instances, a user can select a subset (e.g., volume, toxicity, sentiment) of the set of object-classification signals for generating the narrative feed. As a result, various combinations of object-classification signals can be selected to generate the narrative feed that is customized for the user. Also, by selecting the subset, the user can configure the content-streaming application 102 to increase efficiency and conserve computing resources in processing the unstructured data items, as well as selecting the object-classification signals that are relevant to a target objective.

### 3. Data-Enrichment Layers

The content-streaming application 102 can also include data-enrichment layers 116 configured to determine signal intensities associated with one or more object-classification signals for each narrative-feed object of the set of narrative-feed objects. In some instances, the signal intensities are determined based on the data-enrichment layers 116 processing the plurality of unstructured data items.

In some instances, the data-enrichment layers 116 can implement a focused attention data enrichment feedback loop, in which enrichment and reprioritization layers are iteratively applied on successively fewer high-priority signals using progressively higher intelligence analysis capabilities. The focused attention data enrichment feedback loop can facilitate: (i) deliberate allocation of resources to high-priority or high-value data segments, thereby avoiding unnecessary effort on irrelevant or low-impact data; and (ii) increase of efficiency and effectiveness of processing the unstructured data items when data volume is large and resources (e.g., time, computational power) are limited.

Stated differently, the data-enrichment layers 116 can reprioritize at each stage to run progressively higher-intelligence models (e.g., context checking, deep fake detection, brand risk detection) on certain tasks. In some instances, the higher-intelligence models correspond to larger machine-learning models that consume relatively more computing resources. The higher-intelligence models can be implemented in more advanced applications of models such as agentic workflows or multi-pass architectures. For example, the data-enrichment layers 116 of the content-streaming application 102 can: (i) apply one or more resource-efficient algorithms to the set of narrative-feed objects to generate one or more signal intensities of the signal intensities; (ii) identify a filtered subset of the set of narrative-feed objects; and (iii) applying one or more resource-intensive algorithms to the filtered subset of narrative-feed objects to generate remaining signal intensities of the signal intensities. The one or more resource-intensive algorithms consume more computing resources relative to computing resources consumed by the one or more resource-efficient algorithms.

As an illustrative example, a first data-enrichment layer 118 can initially perform a resource-efficient algorithm for a larger number of object-classification signals, including: (i) volume/engagement analysis 120; (ii) a cohort identification analysis 122; (iii) a sentiment and toxicity detection 124; and (iv) a bot and anomaly detection 126. The less resource-intensive analysis can include determining a count of unstructured data items to determine the volume and engagement associated with the contextual data of the narrative-feed object.

Continuing with the example, a second data-enrichment layer 128 can then perform a resource-intensive analysis on a fewer number of object-classification signals, including: (i) a disinformation context analysis 130; (ii) a deep-fake detection 132; and (iii) a multimodal brand risk detection 134. The more resource-intensive analysis can include using a computer vision model (e.g., a convolutional neural network) that analyzes pixels of images to detect deep-fake images included in unstructured data items. As a result, resource-efficient algorithms (e.g., simple classifiers and near-duplication) can initially be performed to generate larger number of object-classification signals, at which a resource-intensive analyses (e.g., Narrative Mapping) can be performed to generate fewer object-classification signals (e.g., single LLM prompt per task). The above process can continue until the most resource-intensive analyses (e.g., agentic workflows where multiple LLM tasks are combined together, ensemble models with multiple components that work together, identifying tactics techniques and procedures (“TTPs”)) can be performed to generate even fewer number of object-classification signals.

Additionally or alternatively, the data-enrichment layers 116 can assign a categorical value to each of the set of object-classification signals, in which the categorical value can be determined based on the signal intensities. For example, the categorical value can indicate “low signal intensity” or “high signal intensity”, which can be determined based on a magnitude of the signal intensity associated with a corresponding object-classification signal. The categorical value can indicate a particular risk associated with the object-classification signal (e.g., high negative sentiment). Additionally or alternatively, the categorical value can identify a particular opportunity associated with the object-classification signal (e.g., high volume of posts relating to a newly implemented feature).

### 4. Risk-Scoring Module

Once the signal intensities are determined, a risk-scoring module 136 of the content-streaming application 102 can determine a risk score for each narrative-feed object of the set of narrative-feed objects. The risk-scoring module 136 can determine the risk score based on the signal intensities. In some instances, the risk-scoring module 136 determines a risk score of a particular narrative-feed object by applying one or more weights to the corresponding signal intensities. The weights can include values ranging from 0.001, 0.01, 0.1, 0.2, 0.3, 0.4, 0.5, 0.6, 0.7, 0.8, 0.9, or above 0.9, which can be contemplated by a person ordinarily skilled in the art.

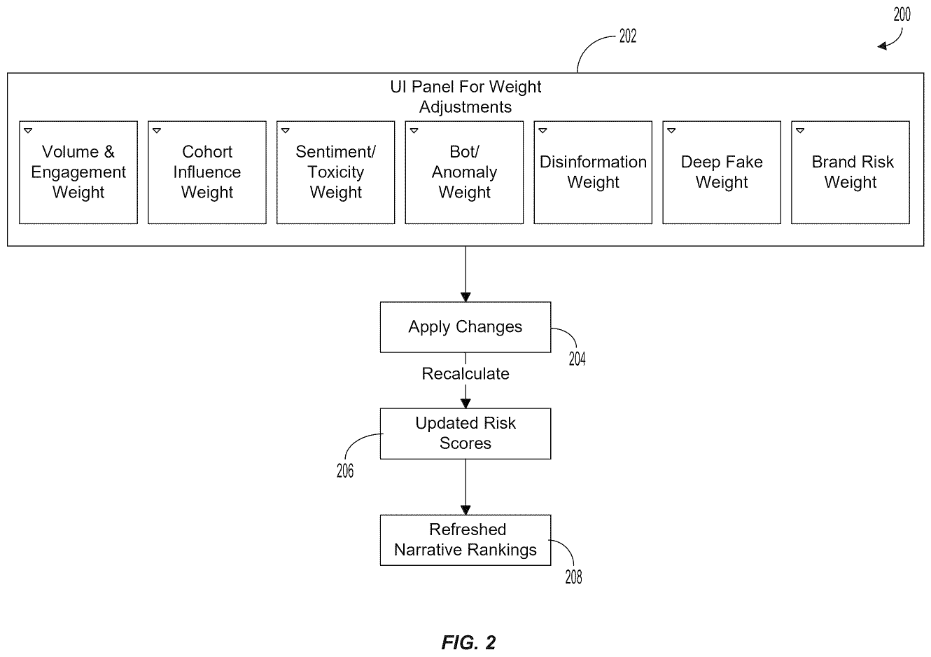

Additionally or alternatively, the risk-scoring module 136 includes a user interface that facilitates adjustment of the weights for each object-classification signal. FIG. 2 illustrates an example schematic diagram 200 of a user interface for adjusting weights associated with object-classification signals, according to some embodiments. A content-streaming application (e.g., the content-streaming application 102 of FIG. 1) can include a user interface 202 that allows weights to be adjusted for the object-classification signals including volume and engagement weight, cohort influence weight, sentiment/toxicity weight, bot/anomaly weight, disinformation weight, deep fake weight, and brand risk weight. The adjusted weights can be saved and applied (block 204) to the corresponding object-classification signals. Based on the adjusted weights, signal intensities of certain object-classification signals can be determined as being more relevant for analyzing the unstructured data items. As a result, an updated risk score can be determined using the signal intensities and the adjusted weights (block 206). In some instances, the content-streaming application can re-rank or re-classify the narrative-feed objects based on their updated risk scores. In some instances, the content-streaming application can re-rank or re-classify the narrative-feed objects in real-time by dynamically re-ranking or re-classifying the narrative-feed objects in response to the weight adjustments (e.g., slider, adjustment to numerical values) being inputted by the user.

### 5. Ranked-Narrative User Interface

Referring back to FIG. 1, a ranked-narrative user interface 138 of the content-streaming application 102 ranks the set of narrative-feed objects to generate a narrative feed. The ranked-narrative user interface 138 can determine ranking of the narrative-feed objects based on their respective risk scores. In some instances, the ranking can be dynamically re-tuned and re-sorted based on additional user input (e.g., by readjusting the weights).

In some instances, the ranked-narrative user interface 138 can implement a narrative feed agent (not shown) to further refine and update the narrative feed (e.g., re-ranking the narrative-feed objects, filtering to show only a subset of the narrative-feed objects) based on user preferences. The narrative feed agent may receive query inputted via a user interface, at which the narrative feed agent can: (i) re-rank the set of narrative-feed objects based on the query; and (ii) generate an updated narrative feed. To re-rank the set of narrative-feed objects, the content-streaming application can adjust the weight values by processing the query (e.g., a natural-language processing algorithm), at which the risk-scoring module 136 can re-apply the adjusted weights to the corresponding signal intensities and generate updated risk scores. The ranked-narrative user interface 138 can then re-rank the set of narrative feed objects based on the updated risk scores. The content-streaming application can re-rank or re-classify the narrative-feed objects in real-time by dynamically re-ranking or re-classifying the narrative-feed objects in response to the query being inputted via the ranked-narrative user interface 138. In some instances, the narrative feed agent can select a subset of the set of narrative-feed objects based on the query and generate the updated narrative feed that includes only the subset of narrative-feed objects.

The query can include unstructured data, such as natural-language text data. The unstructured data can be associated with one or more languages that are inputted using one or more peripheral devices (e.g., keyboard input, voice command). In some instances, the query can be selected based on a list of candidate queries presented on the user interface. In some instances, the query can include multi-modal input such as a combination of text and image data. Additionally or alternatively, the narrative feed agent can be implemented without the risk-scoring module 136. For example, the content-streaming application can initially present the narrative feed that includes the set of narrative-feed objects (without rankings) and rank the narrative-feed objects based on queries inputted by the user.

The ranked-narrative user interface 138 can display a graphical-user interface that facilitates interaction between the user and the content-streaming application. As described above, the query for the narrative feed agent can be inputted using the graphical-user interface to further refine the narrative feed generated by the content-streaming application. In some instances, the ranked-narrative user interface 138 can be implemented using application programming interfaces (APIs). For example, an API message (e.g., an API message that includes a query) can be constructed and transmitted from a user device to the content-streaming application 102 using an API protocol such as Hypertext Markup Language (HTML), Extensible Markup Language (XML), JavaScript®, Cascading Style Sheets (CSS), JavaScript® Object Notation (JSON), and other such protocols and/or structured languages. The API message transmitted by the user device can be parsed by the content-streaming application 102. The content-streaming application 102 can then generate an API response (e.g., the narrative feed) that can be presented on the ranked-narrative user interface 138.

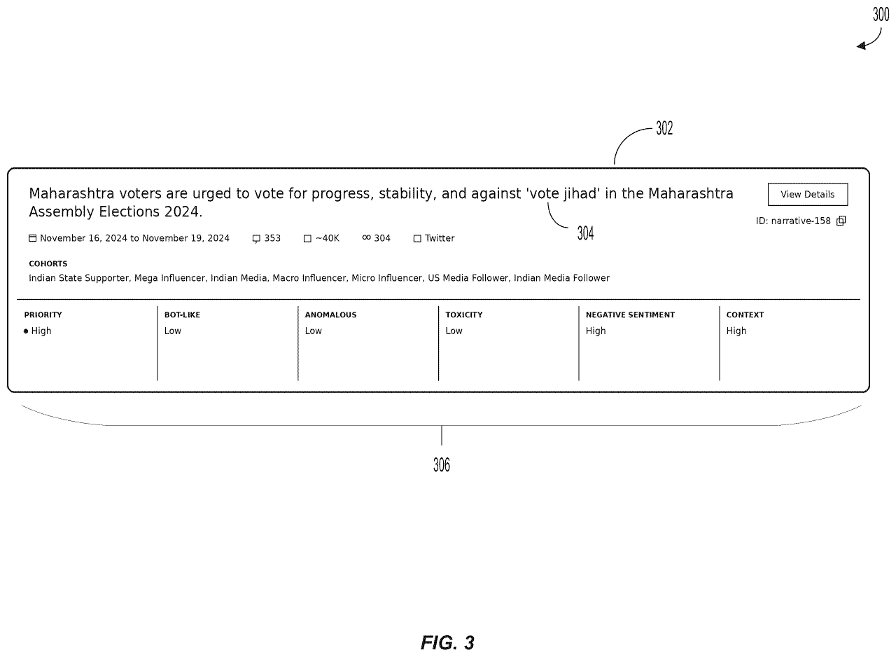

The ranked-narrative user interface 138 can then output the narrative feed. In some instances, the The ranked-narrative user interface 138 can display a narrative-feed object and a corresponding set of object-classification signals at a particular position of a graphical user interface, in which the particular position is determined in accordance with the ranking. FIG. 3 shows an example screenshot 300 of a user interface that displays a narrative-feed object, according to some embodiments. As shown in FIG. 3, a user interface 302 identifies a particular narrative-feed object 304 that identifies contextual data extracted from the unstructured data items. The narrative-feed object 304 can be associated with the object-classification signals 306, which respectively include categorical values (e.g., “low”, “high”) that indicate the magnitude of their respective signal intensities. The categorical value can indicate a particular risk associated with the object-classification signal (e.g., high negative sentiment). Additionally or alternatively, the categorical value can identify a particular opportunity associated with the object-classification signal (e.g., high volume of posts relating to a newly implemented feature). In some instances, the content-streaming application can provide additional user interface elements that facilitate weighting controls to refine results based on user preferences.

Based on the information associated with the narrative feed, various operations can be performed. For example, the presence of a narrative attack can be determined based on the set of object-classification signals associated with a narrative-feed object of the set of narrative-feed objects. In another example, a remedial operation can be determined based on the set of object-classification signals associated with a narrative-feed object of the set of narrative-feed objects. The remedial operation can include blocking IP addresses of accounts that demonstrate bot-like behavior and deleting unstructured data items considered to include disinformation associated with the contextual data.

By analyzing the narrative feed, various systems can trigger (or guide) specific follow-up actions that go well beyond merely displaying aggregated data. For example, brand-impact indicators can be leveraged to initiate crisis-response strategies-such as publishing official statements or reallocating resources to counter negative sentiment. In another example, national security analysts can prioritize the narrative-feed objects for deeper investigation or intelligence gathering. In this way, the narrative feed not only reveals where “the battles” are happening and their underlying context, but also enables real-time interventions and decision-making, thereby transforming static data aggregation into actionable insights.

### B. Methods

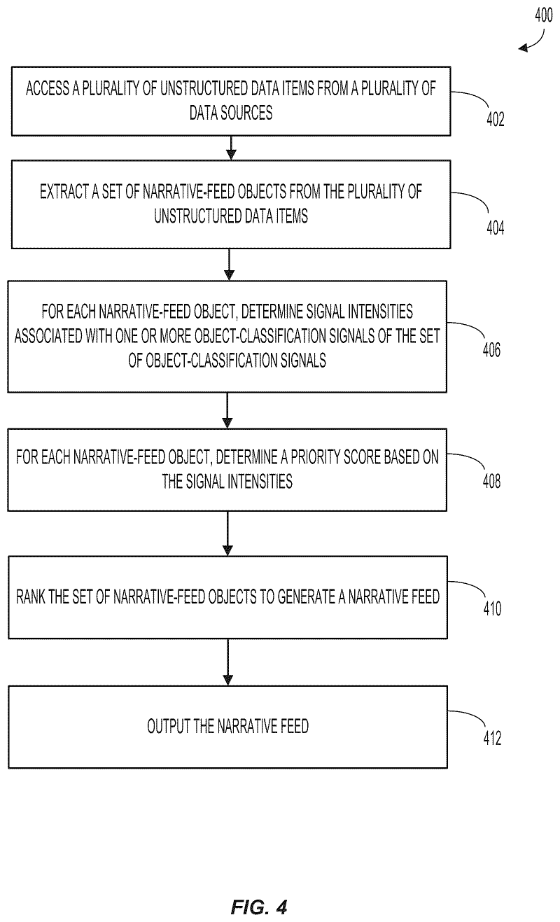

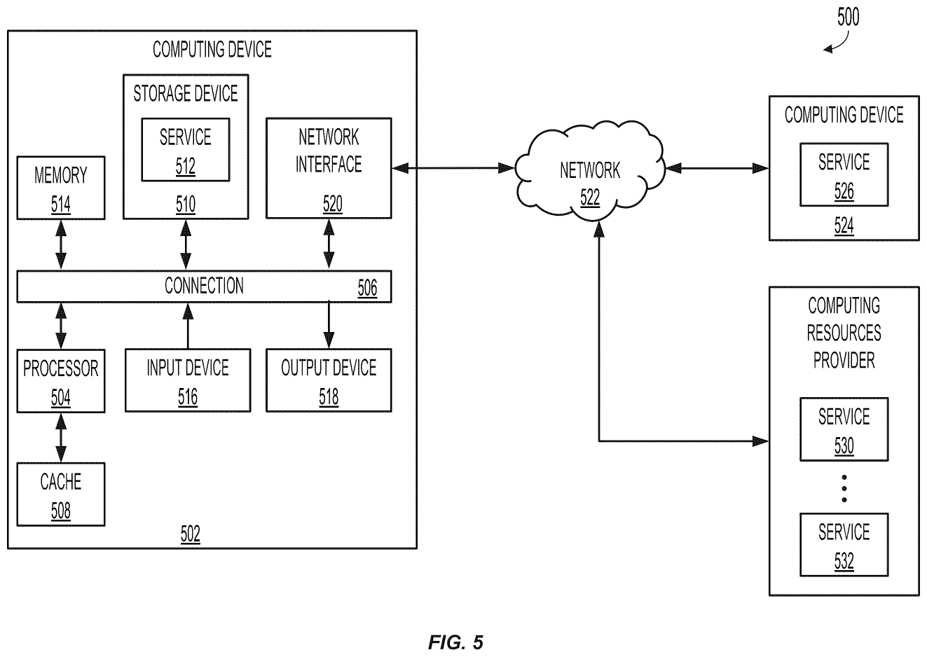

FIG. 4 shows an illustrative example of a process 400 for generating narrative-feed objects, in accordance with some embodiments. For illustrative purposes, the process 400 is described with reference to the components illustrated in FIGS. 1-3, though other implementations are possible. For example, the program code for the content-streaming application of FIG. 1, is executed by one or more processing devices to cause a server system (e.g., the computing device 502 of FIG. 5) to perform one or more operations described herein.

At step 402, the content-streaming application accesses a plurality of unstructured data items from a plurality of data sources. The unstructured data items can include information that does not adhere to a predefined format or organized data model, including free-form text, multimedia files, or other non-standardized formats. Examples of unstructured data items can include social media posts, news articles, videos, audio recordings, text streams uploaded by users, and any combinations thereof. In some instances, a data ingestion layer of the content-streaming application can access the unstructured data item from several digital content sources, including social media APIs, news feeds, forums, chats, and internal databases. The plurality of data sources can be associated with two or more digital-communication platforms.

At step 404, the content-streaming application extracts a set of narrative-feed objects from the plurality of unstructured data items. A narrative-feed object can identify contextual data associated with a corresponding unstructured data item. For example, the content-streaming application can include a data-extraction engine that extracts a mapping of the unstructured data items (e.g., social media posts) to the narrative-feed objects, in which the mapping can be based on thematic or topical similarity and relevant claims associated with the narrative-feed objects. In some instances, two or more narrative-feed objects can be extracted based on a single unstructured data item. Stated differently, an unstructured data item can be mapped to a single narrative-feed object, or multiple narrative-feed objects.

In some instances, the content-streaming application can extract the set of narrative-feed objects by applying a machine-learning model to the plurality of unstructured data items to generate the set of narrative-feed objects. The machine-learning model can include a natural-language processing model trained to parse unstructured and structured data associated with the model prompts. Examples of the machine-learning model can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the machine-learning model can include, but are not limited to, genetic algorithms, backpropagation, reinforcement learning, decision trees, linear classification, artificial neural networks, anomaly detection, and such. In yet other examples, the machine-learning model may include regression analysis, dimensionality reduction, metalearning, reinforcement learning, deep learning, and other such algorithms and/or methods.

In some instances, the machine-learning model is a transformer model (e.g., a large-language model (LLM)) obtained from a models database. In some instances, the machine-learning model is trained using self-supervised learning based on a large corpus of text data. In addition to training the model, various prompts can be used for prompt engineering of the machine-learning model for generating the qualification indicator. Examples of the machine-learning model can include, but are not limited to, BERT model, Claude LLM, Falcon 40B, Ernie, GPT-3, GPT-3.5, GPT 4, Lamda, and Llama.

In some instances, each narrative-feed object of the set of narrative-feed objects can include a set of object-classification signals. An object-classification signal can identify one or more characteristics associated with the contextual data of the narrative-feed object. For example, the set of object-classification signals includes volume, engagement, reach, cohorts, sentiment, toxicity, anomalous behavior, disinformation context, multimodal brand risk, and/or deep fake detection. In some instances, a user can select a subset (e.g., volume, toxicity, sentiment) of the set of object-classification signals for generating the narrative feed. As a result, various combinations of object-classification signals can be selected to generate the narrative feed that is customized for the user.

At step 406, the content-streaming application determines, for each narrative-feed object of the set of narrative-feed objects, signal intensities associated with one or more object-classification signals of the set of object-classification signals. In some instances, the signal intensities are determined based on the plurality of unstructured data items.

In some instances, the content-streaming application can implement a focused attention data enrichment feedback loop, in which enrichment and reprioritization layers are iteratively applied on successively fewer high-priority signals using progressively higher intelligence analysis capabilities. For example, the content-streaming application can: (i) apply one or more resource-efficient algorithms to the set of narrative-feed objects to generate one or more signal intensities of the signal intensities; (ii) identify a filtered subset of the set of narrative-feed objects; and (iii) applying one or more resource-intensive algorithms to the filtered subset of narrative-feed objects to generate remaining signal intensities of the signal intensities. The one or more resource-intensive algorithms consume more computing resources relative to computing resources consumed by the one or more resource-efficient algorithms. The focused attention data enrichment feedback loop can thus facilitate: (i) deliberate allocation of resources to high-priority or high-value data segments, thereby avoiding unnecessary effort on irrelevant or low-impact data; and (ii) increase of efficiency and effectiveness of processing the unstructured data items when data volume is large and resources (e.g., time, computational power) are limited. For example, the content-streaming application can reprioritize at each stage to run higher-intelligence models on high-priority object-classification signals including volume, sentiment, cohorts, disinformation context, and multimodal risk.

Additionally or alternatively, a categorical value can be assigned to each of the set of object-classification signals, in which the categorical value can be determined based on the signal intensities. The categorical value can indicate a particular risk associated with the object-classification signal (e.g., high negative sentiment). Additionally or alternatively, the categorical value can identify a particular opportunity associated with the object-classification signal (e.g., high volume of posts relating to a newly implemented feature).

At step 408, the content-streaming application determines, for each narrative-feed object of the set of narrative-feed objects, a risk score based on the signal intensities. In some instances, the content-streaming application determines the risk scores by applying one or more weights to the signal intensities. For example, the content-streaming application can include a customizable risk-scoring module that enables weights can be determined for each object-classification signal.

At step 410, the content-streaming application ranks the set of narrative-feed objects to generate a narrative feed. The ranking can be determined based on the risk scores of the set of narrative-feed objects. The ranking can be dynamically re-tuned and re-sorted based on additional user input. In some instances, the content-streaming application can further refine the ranking of the set of narrative-feed objects based on user preferences. For example, the content-streaming application can receive a query that includes unstructured data and re-rank the set of narrative-feed objects based on the query to generate an updated narrative feed. The query can include unstructured data, such as natural-language text data. The unstructured data can be associated with one or more languages that are inputted using one or more peripheral devices (e.g., keyboard input, voice command). In some instances, the content-streaming application can re-rank or re-classify the narrative-feed objects in real-time by dynamically re-ranking or re-classifying the narrative-feed objects in response to the query inputted via a user interface.

At step 412, the content-streaming application outputs the narrative feed. In some instances, the content-streaming application can display a narrative-feed object and a corresponding set of object-classification signals at a particular position of a graphical user interface, in which the particular position is determined in accordance with the ranking. For example, the content-streaming application can provide a user interface that presents the narrative feed with the ranked narrative-feed objects and provides adjustable weighting controls to refine results based on user preferences.

Based on the information associated with the narrative feed, various operations can be performed. For example, the presence of a narrative attack can be determined based on the set of object-classification signals associated with a narrative-feed object of the set of narrative-feed objects. In another example, a remedial operation can be determined based on the set of object-classification signals associated with a narrative-feed object of the set of narrative-feed objects. Process 400 terminates thereafter.

### II. EXAMPLE SYSTEMS

FIG. 5 illustrates a computing system architecture 500, including various components in electrical communication with each other, in accordance with some embodiments. The example computing system architecture 500 illustrated in FIG. 5 includes a computing device 502, which has various components in electrical communication with each other using a connection 506, such as a bus, in accordance with some implementations. The example computing system architecture 500 includes a processing unit 504 that is in electrical communication with various system components, using the connection 506, and including the system memory 514. In some embodiments, the system memory 514 includes read-only memory (ROM), random-access memory (RAM), and other such memory technologies including, but not limited to, those described herein. In some embodiments, the example computing system architecture 500 includes a cache 508 of high-speed memory connected directly with, in close proximity to, or integrated as part of the processor 504. The system architecture 500 can copy data from the memory 514 and/or the storage device 510 to the cache 508 for quick access by the processor 504. In this way, the cache 508 can provide a performance boost that decreases or eliminates processor delays in the processor 504 due to waiting for data. Using modules, methods and services such as those described herein, the processor 504 can be configured to perform various actions. In some embodiments, the cache 508 may include multiple types of cache including, for example, level one (L1) and level two (L2) cache. The memory 514 may be referred to herein as system memory or computer system memory. The memory 514 may include, at various times, elements of an operating system, one or more applications, data associated with the operating system or the one or more applications, or other such data associated with the computing device 502.

Other system memory 514 can be available for use as well. The memory 514 can include multiple different types of memory with different performance characteristics. The processor 504 can include any general purpose processor and one or more hardware or software services, such as service 512 stored in storage device 510, configured to control the processor 504 as well as a special-purpose processor where software instructions are incorporated into the actual processor design. The processor 504 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 504 can be a microprocessor, a microcontroller, a digital signal processor (“DSP”), or a combination of these and/or other types of processors. In some embodiments, the processor 504 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 500, an input device can represent any number of input mechanisms, such as a microphone for speech, a touch-sensitive screen for gesture or graphical input, keyboard, mouse, motion input, pen, and other such input devices. An output device 518 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 500. In some embodiments, the input device 516 and/or the output device 518 can be coupled to the computing device 502 using a remote connection device such as, for example, a communication interface such as the network interface 520 described herein. In such embodiments, the communication interface can govern and manage the input and output received from the attached input device 516 and/or output device 518. As may be contemplated, there is no restriction on operating on any particular hardware arrangement and accordingly the basic features here may easily be substituted for other hardware, software, or firmware arrangements as they are developed.

In some embodiments, the storage device 510 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 510 can include hardware and/or software services such as service 512 that can control or configure the processor 504 to perform one or more functions including, but not limited to, the methods, processes, functions, systems, and services described herein in various embodiments. In some embodiments, the hardware or software services can be implemented as modules. As illustrated in example computing system architecture 500, the storage device 510 can be connected to other parts of the computing device using the system connection 506. In some embodiments, a hardware service or hardware module such as service 512, that performs a function can include a software component stored in a non-transitory computer-readable medium that, in connection with the necessary hardware components, such as the processor 504, connection 506, cache 508, storage device 510, memory 514, input device 516, output device 518, and so forth, can carry out the functions such as those described herein.

The disclosed systems and service of a content-streaming application (e.g., the content-streaming application 102 described herein at least in connection with FIG. 1) can be performed using a computing system such as the example computing system illustrated in FIG. 5, using one or more components of the example computing system architecture 500. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for using machine-learning to generate narrative-feed objects (e.g., the content-streaming application described herein at least in connection with FIG. 1) described herein by, for example, executing code using a processor such as processor 504 wherein the code is stored in memory such as memory 514 as described herein. One or more of a user device, a provider server or system, a database system, or other such devices, services, or systems may include some or all of the components of the computing system such as the example computing system illustrated in FIG. 5, using one or more components of the example computing system architecture 500 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 528. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 504 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 514 can be coupled to the processor 504 by, for example, a connector such as connector 506, or a bus. As used herein, a connector or bus such as connector 506 is a communications system that transfers data between components within the computing device and may, in some embodiments, be used to transfer data between computing devices. The connector 506 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 514 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 514 can also include magnetic or optical data storage media including read-only (e.g., CD ROM and DVD ROM) or otherwise (e.g., CD or DVD). The memory can be local, remote, or distributed.

As described above, the connector 506 (or bus) can also couple the processor 504 to the storage device 510, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 510. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 506 can also couple the processor 504 to a network interface device such as the network interface 520. The interface can include one or more of a modem or other such network interfaces including, but not limited to those described herein. It will be appreciated that the network interface 520 may be considered to be part of the computing device 502 or may be separate from the computing device 502. The network interface 520 can include one or more of an analog modem, Integrated Services Digital Network (ISDN) modem, cable modem, token ring interface, satellite transmission interface, or other interfaces for coupling a computer system to other computer systems. In some embodiments, the network interface 520 can include one or more input and/or output (I/O) devices. The I/O devices can include, by way of example but not limitation, input devices such as input device 516 and/or output devices such as output device 518. For example, the network interface 520 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 502 can be connected to one or more additional computing devices such as computing device 524 via a network 522 using a connection such as the network interface 520. In such embodiments, the computing device 524 may execute one or more services 526 to perform one or more functions under the control of, or on behalf of, programs and/or services operating on computing device 502. In some embodiments, a computing device such as computing device 524 may include one or more of the types of components as described in connection with computing device 502 including, but not limited to, a processor such as processor 504, a connection such as connection 506, a cache such as cache 508, a storage device such as storage device 510, memory such as memory 514, an input device such as input device 516, and an output device such as output device 518. In such embodiments, the computing device 524 can carry out the functions such as those described herein in connection with computing device 502. In some embodiments, the computing device can be connected to a plurality of computing devices such as computing device 524, each of which may also be connected to a plurality of computing devices such as computing device 524. Such an embodiment may be referred to herein as a distributed computing environment.

The network 522 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 522 can be wired connections, wireless connections, or combinations thereof. Communications via the network can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 522, within the computing device 502, within the computing device 524, or within the computing resources provider 528 can include information, which also may be referred to herein as content. The information may include text, graphics, audio, video, haptics, and/or any other information that can be provided to a user of the computing device such as the computing device 502. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 502 and presented to a user of the computing device using forms that are perceptible via sight, sound, smell, taste, touch, or other such mechanisms. In some embodiments, communications over the network 522 can be received and/or processed by a computing device configured as a server. Such communications can be sent and received using PUP: Hypertext Preprocessor (“PHP”), Python™, Ruby, Perl® and variants, Java®, HTML, XML, or another such server-side processing language.

In some embodiments, the computing device 502 and/or the computing device 524 can be connected to a computing resources provider 528 via the network 522 using a network interface such as those described herein (e.g. network interface 520). In such embodiments, one or more systems (e.g., service 530 and service 532) hosted within the computing resources provider 528 (also referred to herein as within “a computing resources provider environment”) may execute one or more services to perform one or more functions under the control of, or on behalf of, programs and/or services operating on computing device 502 and/or computing device 524. Systems such as service 530 and service 532 may include one or more computing devices such as those described herein to execute computer code to perform the one or more functions under the control of, or on behalf of, programs and/or services operating on computing device 502 and/or computing device 524.

For example, the computing resources provider 528 may provide a service, operating on service 530 to store data for the computing device 502 when, for example, the amount of data that the computing device 502 exceeds the capacity of storage device 510. In another example, the computing resources provider 528 may provide a service to first instantiate a virtual machine (VM) on service 532, use that VM to access the data stored on service 532, perform one or more operations on that data, and provide a result of those one or more operations to the computing device 502. Such operations (e.g., data storage and VM instantiation) may be referred to herein as operating “in the cloud,” “within a cloud computing environment,” or “within a hosted virtual machine environment,” and the computing resources provider 528 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 528 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 530 and service 532 may implement versions of various services (e.g., the service 512 or the service 526) on behalf of, or under the control of, computing device 502 and/or computing device 524. Such implemented versions of various services may involve one or more virtualization techniques so that, for example, it may appear to a user of computing device 502 that the service 512 is executing on the computing device 502 when the service is executing on, for example, service 530. As may also be contemplated, the various services operating within the computing resources provider 528 environment may be distributed among various systems within the environment as well as partially distributed onto computing device 524 and/or computing device 502.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 502) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 400 of FIG. 4). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 502.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing a plurality of unstructured data items from a plurality of data sources;
extracting a set of narrative-feed objects from the plurality of unstructured data items, wherein a narrative-feed object of the set of narrative-feed objects identifies contextual data associated with a corresponding unstructured data item, and wherein each narrative-feed object of the set of narrative-feed objects includes a set of object-classification signals;
determining, for each narrative-feed object of the set of narrative-feed objects, signal intensities associated with one or more object-classification signals of the set of object-classification signals, wherein the signal intensities are determined based on the plurality of unstructured data items;
determining, for each narrative-feed object of the set of narrative-feed objects, a risk score based on the signal intensities;
ranking the set of narrative-feed objects to generate a narrative feed, wherein the ranking is determined based on the risk scores of the set of narrative-feed objects; and
outputting the narrative feed.

2. The computer-implemented method of claim 1, further comprising determining a remedial operation based on the set of object-classification signals associated with a narrative-feed object of the set of narrative-feed objects.

3. The computer-implemented method of claim 1, further comprising determining a presence of a narrative attack based on the set of object-classification signals associated with a narrative-feed object of the set of narrative-feed objects.

4. The computer-implemented method of claim 1, wherein determining the signal intensities includes assigning a categorical value to each of the set of object-classification signals.

5. The computer-implemented method of claim 1, wherein outputting the narrative feed includes causing a narrative-feed object and a corresponding set of object-classification signals to be displayed at a particular position of a graphical user interface, and wherein the particular position is determined in accordance with the ranking.

6. The computer-implemented method of claim 1, wherein determining the signal intensities includes:
applying one or more resource-efficient algorithms to the set of narrative-feed objects to generate one or more signal intensities of the signal intensities;
identifying a filtered subset of the set of narrative-feed objects; and
applying one or more resource-intensive algorithms to the filtered subset of narrative-feed objects to generate remaining signal intensities of the signal intensities, wherein the one or more resource-intensive algorithms consume more computing resources relative to computing resources consumed by the one or more resource-efficient algorithms.

7. The computer-implemented method of claim 1, wherein generating the narrative feed further includes:
receiving a query that includes unstructured data; and
re-ranking the set of narrative-feed objects based on the query to generate an updated narrative feed.

8. A system comprising:
one or more processors; and
a non-transitory computer-readable medium storing instructions that when executed by the one or more processors, cause the one or more processors to perform operations including:
accessing a plurality of unstructured data items from a plurality of data sources;
extracting a set of narrative-feed objects from the plurality of unstructured data items, wherein a narrative-feed object of the set of narrative-feed objects identifies contextual data associated with a corresponding unstructured data item, and wherein each narrative-feed object of the set of narrative-feed objects includes a set of object-classification signals;
determining, for each narrative-feed object of the set of narrative-feed objects, signal intensities associated with one or more object-classification signals of the set of object-classification signals, wherein the signal intensities are determined based on the plurality of unstructured data items;
determining, for each narrative-feed object of the set of narrative-feed objects, a risk score based on the signal intensities;
ranking the set of narrative-feed objects to generate a narrative feed, wherein the ranking is determined based on the risk scores of the set of narrative-feed objects; and
outputting the narrative feed.

9. The system of claim 8, wherein the instructions further cause the one or more processors to perform operations including:
determining a remedial operation based on the set of object-classification signals associated with a narrative-feed object of the set of narrative-feed objects.

10. The system of claim 8, wherein the instructions further cause the one or more processors to perform operations including:
determining a presence of a narrative attack based on the set of object-classification signals associated with a narrative-feed object of the set of narrative-feed objects.

11. The system of claim 8, wherein determining the signal intensities includes assigning a categorical value to each of the set of object-classification signals.

12. The system of claim 8, wherein outputting the narrative feed includes causing a narrative-feed object and a corresponding set of object-classification signals to be displayed at a particular position of a graphical user interface, and wherein the particular position is determined in accordance with the ranking.

13. The system of claim 8, wherein determining the signal intensities includes:
applying one or more resource-efficient algorithms to the set of narrative-feed objects to generate one or more signal intensities of the signal intensities;
identifying a filtered subset of the set of narrative-feed objects; and
applying one or more resource-intensive algorithms to the filtered subset of narrative-feed objects to generate remaining signal intensities of the signal intensities, wherein the one or more resource-intensive algorithms consume more computing resources relative to computing resources consumed by the one or more resource-efficient algorithms.

14. The system of claim 8, wherein generating the narrative feed further includes:
receiving a query that includes unstructured data; and
re-ranking the set of narrative-feed objects based on the query to generate an updated narrative feed.

15. A non-transitory computer-readable medium storing instructions that when executed by one or more processors, cause the one or more processors to perform operations including:
accessing a plurality of unstructured data items from a plurality of data sources;
extracting a set of narrative-feed objects from the plurality of unstructured data items, wherein a narrative-feed object of the set of narrative-feed objects identifies contextual data associated with a corresponding unstructured data item, and wherein each narrative-feed object of the set of narrative-feed objects includes a set of object-classification signals;
determining, for each narrative-feed object of the set of narrative-feed objects, signal intensities associated with one or more object-classification signals of the set of object-classification signals, wherein the signal intensities are determined based on the plurality of unstructured data items;
determining, for each narrative-feed object of the set of narrative-feed objects, a risk score based on the signal intensities;
ranking the set of narrative-feed objects to generate a narrative feed, wherein the ranking is determined based on the risk scores of the set of narrative-feed objects; and
outputting the narrative feed.

16. The non-transitory computer-readable medium of claim 15, wherein the instructions further cause the one or more processors to perform operations including:
determining a remedial operation based on the set of object-classification signals associated with a narrative-feed object of the set of narrative-feed objects.

17. The non-transitory computer-readable medium of claim 15, wherein the instructions further cause the one or more processors to perform operations including:
determining a presence of a narrative attack based on the set of object-classification signals associated with a narrative-feed object of the set of narrative-feed objects.

18. The non-transitory computer-readable medium of claim 15, wherein outputting the narrative feed includes causing a narrative-feed object and a corresponding set of object-classification signals to be displayed at a particular position of a graphical user interface, and wherein the particular position is determined in accordance with the ranking.

19. The non-transitory computer-readable medium of claim 15, wherein determining the signal intensities includes:
applying one or more resource-efficient algorithms to the set of narrative-feed objects to generate one or more signal intensities of the signal intensities;
identifying a filtered subset of the set of narrative-feed objects; and
applying one or more resource-intensive algorithms to the filtered subset of narrative-feed objects to generate remaining signal intensities of the signal intensities, wherein the one or more resource-intensive algorithms consume more computing resources relative to computing resources consumed by the one or more resource-efficient algorithms.

20. The non-transitory computer-readable medium of claim 15, wherein generating the narrative feed further includes:
receiving a query that includes unstructured data; and
re-ranking the set of narrative-feed objects based on the query to generate an updated narrative feed.
